(19) United States
(12) Patent Application Publication
(10) Pub. No.: US 2025/0367635 A1
(43) Pub. Date: Dec. 4, 2025

(54) Functionalized Fullerenes for Efficient Lithium Extraction.

(71) Applicants: Terry Earl Brady, The Valley (AI); Anthony Lee Dellinger, Burlington, NC (US); Abed Alqader Ibrahim, Greensboro, NC (US); Melinda K. M. Goddard, The Valley (AI)

(72) Inventors: Terry Earl Brady, The Valley (AI); Anthony Lee Dellinger, Burlington, NC (US); Abed Alqader Ibrahim, Greensboro, NC (US); Melinda K. M. Goddard, The Valley (AI)

(21) Appl. No.: 18/960,242

(22) Filed: Nov. 26, 2024

Related U.S. Application Data
(63) Continuation-in-part of application No. 18/675,650, filed on May 28, 2024.

(51) Int. Cl. B01J 20/20; B01D 15/02; B01J 20/22; B01J 20/32; B01J 20/34; C01B 32/156; C22B 3/24; C22B 26/12

(52) U.S. Cl. CPC B01J 20/205; B01D 15/02; B01J 20/22; B01J 20/3204; B01J 20/3219; B01J 20/3255; B01J 20/3425; B01J 20/3475; C01B 32/156; C22B 3/24; C22B 26/12

(57) ABSTRACT

The present CIP builds upon and extends the work presented in the parent invention by broadening the scope of functionalized fullerene technology. While the parent application focused on enhancing the safety and efficacy of ophthalmic and other medical solutions through the selective removal of preservatives, this CIP adapts those core functionalization strategies and filtration technology for the extraction of lithium ions from brine and other solutions (e.g., earthen source circulates). The functionalization techniques described herein demonstrate the versatility and scalability of fullerene-based systems for diverse applications, ranging from biomedical solutions to critical industrial processes such as lithium recovery. Together, these innovations illustrate the significant potential of functionalized fullerenes to address pressing challenges across multiple fields, unifying the parent and CIP in their commitment to efficient, selective and sustainable solutions.

### FIELD OF THE INVENTION

The present invention relates to advanced filtration and extraction applications, specifically to the use of functionalized fullerene-based materials for targeted ion capture and removal. The parent invention focused on adsorption and chelation-based filters for dispensing devices to remove preservatives and contaminants from ophthalmic and other medical solutions. This continuation-in-part (CIP) expands the technology for energy storage and resource extraction applications. Whether used as a discrete system or for component integration into industrial lithium extraction pools—and ultimately battery design, this innovation would provide specificity and efficiency in extracting lithium ions from complex brine solutions or other solutions (e.g., earthen sources) using porous wafer substrates functionalized with lithium-chelating fullerenes.

### BACKGROUND

The focus of this CIP centers on lithium due to its relevance to high-performance battery technology and increasing demand from energy storage and related industries, such as electric vehicles. Lithium, often considered the pinnacle of high-energy-density materials, remains vital in the future of such systems. The need for more sustainable, faster and specific lithium extraction is thus increasing with such demands. However, conventional lithium extraction from brine relies on solar evaporation, which is slow, inefficient and environmentally problematic. Whereas emergent methods also include acid leaching and gas fracking, this invention provides an efficient alternative to established and emergent lithium harvesting methods.

This CIP builds on the parent application, which introduced a fullerene-based filtration system for removing preservatives primarily from ophthalmic and other medical solutions. The functionalized fullerene of the parent disclosure was integrated into cellulose acetate (CA) membranes that are adaptable for various dispensing pathways and prevention of cytotoxic exposure from preservatives like benzalkonium chloride (BAK) and thimerosal (mercury). With the application of carbon-based materials to porous wafer substrates, the present CIP invention optimizes functionalized lithium-chelating fullerenes for lithium extraction from brine or other solutions.

Nanoparticles have been incorporated in membrane fabrication as nanofillers for enhanced performance relative to traditional polymers. Many types of nanoparticles have been used to modify membranes including zeolite, graphite, silica, and carbon nanotubes (CNTs). These modifications have contributed to greater membrane flux, mechanical, chemical and antifouling properties. Carbon-based nanoparticles have attracted special attention due to their unique and distinctive mechanical properties, flexibility and stiffness, as well as electrical and thermal conductivities with high water treatment efficiency in removal of various chemical and biological contaminants. The dispersion capacity of carbon-based nanoparticles in a variety of polymer matrices such as polyvinylidene fluoride, polystyrene, polyethersulfone, polyacrylonitrile, polyamide, and CA has also facilitated further commercial developments.

Carbon-based nanoparticles, particularly CNTs, have also been shown to remove a wide range of contaminants, including heavy metals, metalloids, and organics when used as an adsorbent media (Baby et al., 2019; Fiyadh et al., 2019; Bassyouni et al., 2020). The excellent adsorbent properties have been attributed to the increased specific surface area, the mesoporous (super-nanoporous) structure, the CNTs negative surface charge, and the CNT and aromatic compounds T-T stacking interaction. These properties make them a convenient choice for polymer composite modification.

Fullerene nanoparticles, with their unique spherical geometry and closed carbon shell, offer interesting possibilities in environmental and technological fields. Fullerenes exhibit a high degree of electron mobility and photophysical properties that facilitate capturing and reacting with free radicals. This characteristic of fullerenes makes these nanoparticles particularly effective in applications requiring antioxidant activity, such as in the degradation of environmental pollutants or in the stabilization of materials against oxidative damage. Of note, fullerenes have the ability to undergo functionalization, which allows for the enhancement of their solubility and interaction with various substrates. Functional groups can be attached to the fullerene structure, facilitating specific interactions with target molecules. This functionalization is key to expanding the range of applications of fullerenes, from delivery systems where fullerenes serve as drug carriers, to sensors and catalysts, where fullerenes can interact selectively with specific chemicals.

As a primary component of the parent invention, fullerenes are characterized by their unique spherical shapes and cage-like structures. Fullerenes represent a novel class of carbon allotropes that have influenced advancements in materials science and biotechnology within various medical fields. These nanomaterials consist of carbon atoms linked by single and double bonds to form closed or partially closed meshwork cages, with each carbon atom hybridized in the sp2 state. The electronic properties of fullerenes stem from their extensive x-bond conjugation and distinct p-orbitals, which facilitate electron reception and scavenging abilities, making them suitable for a range of applications, especially in medicine due to their biocompatibility. A key attribute associated with fullerenes is the versatility to modify their surface properties through functional groups and encapsulate molecules inside of the carbon cages. The structural integrity of fullerenes, characterized by a spherical arrangement of planar benzene rings, places unique constraints on the x-electron orbitals. This configuration enables remarkable electron transfer capabilities, attributable to their low reorganization energy and the presence of low-lying excited states, as both singlets and triplets.

Carbon nanoparticles, including CNTs, nanodots, fullerenes, etc., have been previously used as detectors for mercury. The fullerenes provide high surface area, high reactivity (due to the x-x interactions) and the versatility for functionalization to target specific molecules, as above. Fullerene nanoparticles functionalized with thiol groups for different applications and sulfur have been used in many fields, particularly in mercury sensing, due to its photostability. However, using sulfur nanoparticles can decrease activity due to the larger particle size. One solution to this issue has been to use sulfur nanodots, which are relatively small and offer a larger surface area, which can facilitate more activity.

With respect to the present invention, lithium hydration energy, approximately −127.5 kcal/mol (about −533 KJ/mol), is also higher than that of sodium −99.7 kcal/mol (about −417 kJ/mol) and potassium −79.6 kcal/mol (about −333 KJ/mol) [Izatt et. al., 1985]. This greater hydration energy means lithium ions in aqueous solution are more tightly bound to water molecules, making them more challenging to dehydrate and bind [Izzat et al., 1985]. However, in the present invention, the selective design of 2-Aminomethyl-15-crown-5 ether effectively reduces the dehydration energy threshold by presenting a selective binding environment, thus enabling lithium binding with reduced energy input compared to other ions.

The binding affinity of lithium ions to crown ethers is also high, whereby the selectivity coefficient of lithium over sodium for certain crown ethers can reach values as high as 10:1 in brine-like conditions [Izzat et al., 1985]. Given this coefficient, in the preferred functionalization group in the present invention, 15-crown-5 ether, and under the same concentration conditions, the crown ether will bind lithium ions ten times more readily than sodium ions, thus favoring lithium recovery from complex mixtures [Izzat et al., 1985].

Lithium ions also have a notably smaller ionic radius (0.90 Å) compared to sodium (1.21 Å) and potassium (1.51 Å) [Morris, 2008]. Herein crown ethers are functionalized with cavity sizes that match the lithium ionic radius, allowing these groups to selectively encapsulate lithium ions relative to larger cations. In the present invention, 2-Aminomethyl-15-crown-5 ether thus have a cavity size optimized to the lithium radius, achieving a selective fit that excludes larger ions like sodium and potassium [Izatt et. al., 1985].

Once lithium is extracted using functionalized fullerenes, which are soluble in organic solvents (e.g., toluene, benzene, or chloroform), efficient separation from wafers allows for regeneration and recycling of fullerenes. Thus, after extraction, wafers can be submerged in a compatible solvent to dissolve and recover them, ensuring that the functional ligands remain intact during recycling. Alternatively, pH shifts may be utilized for detachment, however, they can weaken bonds of fullerenes attached to the wafers with weak covalent or ionic interactions (e.g., carboxylates or amines). For example, acidic environments can protonate functional groups, disrupting bonds; whereas basic environments can cleave certain linkages or break weak electrostatic attachments. Likewise, the application of heat through a thermal treatment can be utilized to break non-covalent interactions, especially in cases where the fullerenes are attached through physical adsorption or weak surface interactions. For large-scale applications, ultrasonic waves in a solvent bath can also be employed to break the physical adsorption forces between the fullerenes and the wafer for detachment without damaging the fullerene structures.

Functionalized fullerenes also provide inherent thermal stability due to their robust carbon structure and ability to dissipate heat. When incorporated into lithium-ion batteries, the lithium-bound fullerenes could thus mitigate risks associated with thermal runaway, reducing the likelihood of overheating or fire hazards. Additionally, the mechanical integrity of fullerenes provides enhanced structural stability, minimizing electrode degradation during repeated charge/discharge cycles and extending battery lifespan. The unique binding properties of lithium-bound fullerenes also prevent the formation of lithium dendrites, a common issue in conventional lithium-ion batteries that can lead to short circuits and catastrophic failure. By maintaining a controlled and stable lithium distribution, the functionalized fullerenes in the proposed invention could improve the overall safety profile of current battery technology.

Building on the parent invention, fullerenes present a unique structure, characterized by an immense relative surface area, extensive x-conjugation, and the ability to undergo diverse functionalization. In turn, this can achieve unique chelating properties for specifically binding lithium ions without interference from competing cations, such as sodium, magnesium, calcium or potassium. This adaptation promises utility for highly efficient and environmentally sustainable lithium extraction from brine or other solutions (e.g., earthen sources) as a discrete system or for integration into industrial lithium extraction pools. Following extraction, the capture wafers present further utility directly as battery components or from which lithium can be eluted as a pure substrate.

### SUMMARY OF THE INVENTION

Building on the parent invention using functionalized fullerenes for selective filtration in ophthalmic and other medical dispensing formats, this CIP harnesses the immense surface area and unique chelating properties of fullerenes when specifically functionalized with 2-Aminomethyl-15-crown-5 ethers for lithium ion capture from brine solutions. A robust covalent attachment with the use of porous wafers and nano-roughened surfaces helps ensure optimal performance in high-shear conditions. This CIP invention utility lies in its application for energy storage technologies, addressing challenges in lithium-ion battery production, extraction efficiency, sustainability and industrial scalability as a component or purification process medium.

This CIP thus describes a mechanical and chemical process for lithium extraction from brine or other solutions. Wherein fullerenes are integrated into a mixing chamber equipped with a rotating propeller, facilitating continuous and accelerated extraction from complex mixtures. Porous wafer substrates are attached to the propeller and functionalized with lithium-chelating fullerenes, designed to efficiently bind lithium ions in the brine or other solutions (e.g., earthen sources, geothermal waters, seawater, wastewater, industrial effluents, mining runoff, battery recycling processes or other lithium-containing sources). The method achieves efficiency by monitoring the propeller weight until reaching a target consistent with the saturation of lithium, wafer removal, replacement, and onward integration of extraction wafers as components, or elution for lithium substrate purification. The process is then repeated by pumping fresh brine or other solutions into the chamber for continuous lithium harvesting. This design enables accelerated extraction cycles, as the functionalized fullerenes rapidly bind lithium ions without prolonged evaporation or harsh chemical treatments. The extracted lithium demonstrates consistent purity and electrochemical stability for optimal energy density, cycle life, and safety of lithium-based batteries.

Lithium bound to an empty cage fullerene structure also enhances ion mobility and spatial distribution, which could facilitate production of lighter batteries with comparable or increased energy density. Combined with the exceptional specificity and binding of functionalized fullerenes, this configuration offers dense packing properties, enabling exceptional energy storage and the potential for rapid recharging without conventional structural constraints, allowing for innovative battery configurations, e.g., flexible rope-like structures. Additionally, the functionalization of lithium to the fullerene shell may confer inherent safety advantages, reducing the risk of overheating or chemical fires in lithium batteries.

### BRIEF DESCRIPTION OF THE DRAWINGS

FIG. 1 is a depiction of a lithium extraction system consisting of a mixing chamber (110) linked to a feeding pump (100) for brine solution entry through the inlet (105). Within the chamber, a rotating propeller (120) with wafers (125) coated with lithium-chelating fullerenes (130) facilitate lithium ion (140) capture. The system includes a balance (115) to monitor wafer saturation, enabling timely replacement with fresh wafers for optimal extraction. An effluent outlet (135) allows for the removal of depleted brine. The figure also features a magnified view of the wafer structure, illustrating the interaction between the fullerenes and lithium ions.

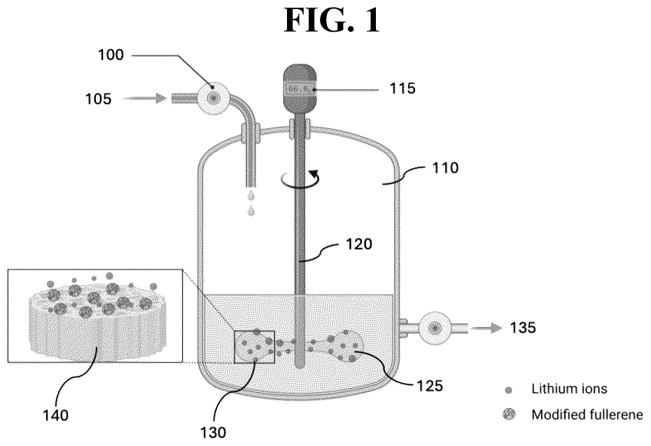

FIG. 2 is a molecular representation of the covalent attachment of the 2-Aminomethyl-15-crown-5 ether to a malonic-acid functionalized C₆₀ fullerene.

### DETAILED DESCRIPTION OF THE INVENTION

The present CIP extends the application of the parent to the specific extraction of lithium ions from brine and other solutions, addressing a critical need for efficient lithium recovery in energy storage and battery applications. In the parent application, functionalized fullerene derivatives were incorporated into amine-functionalized CA membranes to create a selective filtration system to remove preservative compounds from ophthalmic and other medical solutions, ensuring patient safety and therapeutic efficacy. The functionalization strategies enhance filtration and target specific chemical interactions, enabling specific and efficient additive and contaminant removal.

This CIP adapts the functionalization concepts for lithium extraction from brine or other solutions using modified C₆₀ fullerenes, as an exemplary fullerene configuration, but not limited to C₆₀. This application focuses on leveraging the unique chelating and binding properties of fullerenes described in the parent application, but it expands the breadth to teach specifically capturing lithium ions in the presence of competing ions, such as sodium, potassium, calcium and magnesium.

To achieve functionalization, a reactive linker is first introduced onto the surface of fullerene nanoparticles to enable the subsequent attachment of 2-Aminomethyl-15-crown-5 ether. An established direct method for functionalization of fullerenes is the Bingel reaction, which involves the addition of malonate groups to the fullerene surface through cyclopropanation in the presence of a base, such as 1,8-Diazabicyclo(5.4.0) undec-7-ene (DBU); this creates reactive sites such as hydroxyl groups on the fullerenes, forming stable bonds without compromising the fullerene core structure. This functionalization step is crucial to establish specific sites on the fullerene, where crown ethers can be covalently attached, creating a highly stable and uniform material.

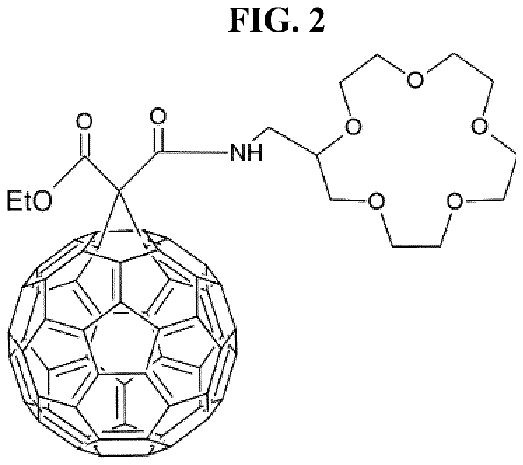

After fullerene surface functionalization, 2-Aminomethyl-15-crown-5 ether is introduced. One of carboxylic acid groups on the functionalized fullerene is activated with EDC (1-ethyl-3-(3-dimethylaminopropyl) carbodiimide and NHS (N-hydroxysuccinimide), converting it into an NHS ester. This activated site reacts with the amine group of the 2-Aminomethyl-15-crown-5 ether to form a stable amide bond between the malonic acid and the crown ether [FIG. 2]. Covalent bonding ensures that the 2-Aminomethyl-15-crown-5 ether remains attached to the fullerenes under high-shear or flow conditions, which would be expected for rapid, continuous extraction in the described system or with integration of this invention into industrial lithium extraction pools.

Covalent bonding of fullerenes and crown ethers affords control of crown ether density on the fullerene surface by varying the amount of reactive linker groups introduced during initial functionalization. It also maintains the positioning of the crown ethers for optimal specificity and lithium-ion binding capacity. Density control thus prevents overcrowding, which could reduce lithium ion access due to the steric hindrance or surface saturation.

Using 2-Aminomethyl-15-crown-5 ether functionalized fullerenes thus ensures high affinity for lithium, from a combination of ionic radius compatibility, hydration energy ratios and binding affinity constants relative to competing ions in brine and other solutions. As such, steric effects play a crucial role in the selectivity of crown ethers, whose cyclic structure provides a cavity that is optimally sized to create an electrostatic environment that promotes lithium-ion binding while repelling ions with larger radii and weaker hydration constants, such as sodium or potassium.

In the primary embodiment, functionalized C₆₀ fullerenes are integrated into the surface of a wafer structure through a precise surface-coating process. The wafer surfaces, composed of a porous or hydrophilic material, are “nano-roughened” to enhance adhesion and ensure stable covalent bonding of the fullerenes. Before application, the fullerene nanoparticles are modified with lithium-selective groups (e.g., crown ethers) and dispersed into a solvent to ensure uniform distribution. Controlled application techniques, such as but not limited to LbL assembly allow precise attachment of fullerenes for optimal surface coverage to maximize ion accessibility while ensuring structural integrity, especially for high-shear environments. Once dried and cured, the wafers are ready for use in the extraction system, offering optimal surface area for lithium-ion capture in brine or other solutions. This process thus ensures that the fullerenes remain securely attached during operation, withstand mechanical stress from the mixing propeller, and maintain lithium binding efficiency throughout multiple extraction cycles.

To maximize the interaction between lithium ions and 2-Aminomethyl-15-crown-5 ether-functionalized fullerenes, precise control over physical forces ensures that lithium ions efficiently bind to the functionalized fullerenes, optimizing lithium scavenging. In the present invention, propeller-induced fluid dynamics generate turbulence and shear forces, accelerate convection, and distribute lithium ions throughout the brine; whereas shear forces increase the rate of ion exchange by thinning the boundary layer around the fullerene to enhance diffusion. This agitation promotes contact between the lithium ions and the functionalized fullerenes. The mixing intensity is optimized to achieve sufficient interaction without disrupting fullerene surface structures (i.e., membrane, wafer or propeller).

In the primary embodiment of the present invention, a porous wafer is utilized to control agitation, maintain structural integrity, and significantly increase the effective surface area available for lithium-ion capture. Porous substrates provide multiple binding sites within their micro- and mesopores, enabling enhanced ion interaction density and adsorption capacity per unit area, maximizing lithium uptake relative to non-porous surfaces. Porous wafers also help stabilize fullerenes by anchoring them within pore structures, reducing their mobility and strengthening attachment for use in high-shear environments.

In another aspect of the present invention, the application of nano-roughness to the wafer surface significantly improves adhesion strength for fullerene attachment. As such, this nanoengineering technique increases the surface energy and contact points between the fullerene molecules and the substrate, creating more stable attachments that resist detachment under shear forces.

The preferred embodiment of this CIP demonstrates attachment of 2-Aminomethyl-15-crown-5 ether on fullerenes bound to capture wafers to selectively chelate lithium ions from brine or other solutions using a calibrated, rotating propeller in a controlled chamber for continuous lithium extraction. In doing so, crown ethers are covalently attached to the surface of fullerene C₆₀ molecules to facilitate selective binding of alkali metals like lithium. This integration leverages the unique structural and chemical properties of crown ethers and fullerenes to optimize lithium specificity, stability and performance, particularly in complex substrates like brine. The covalent bonding ensures that the crown ethers remain securely attached to the fullerene surface under high-shear or flow conditions, while the cavity size of the crown ethers allows for specific binding of lithium ions over competing ions, such as sodium, potassium, calcium and magnesium.

In the present invention and as described in the drawings, the primary components of the lithium extraction system include: a mixing chamber, into which brine solution is added through a fecding pump; a rotating propeller that supports functionalized fullerene wafers inside the chamber; a balance used to detect lithium saturation and timing for lifting the propeller and spent wafers; and an effluent outlet that allows for drainage prior to introduction of fresh brine.

The overall lithium-ion extraction process in the present invention would encompass: (1) Synthesis of Functionalized Fullerenes: C₆₀ molecules covalently modified with 2-Aminomethyl-15-crown-5 ethers, as described in the preferred embodiment. (2) Introduction to Brine: Functionalized fullerene wafers are added to brine. (3) Lithium Scavenging: As lithium ions bind to the functionalized fullerenes, a propeller mixing system enhances ion-nanoparticle interactions. The propeller has adjustable rotational speeds (e.g., 100-200 RPM), to ensure optimal system shear rates for lithium ion-fullerene interaction while maintaining structural integrity, verified through mechanical adhesion tests on fullerene-coated wafers. (4a) Continuous Extraction: Once a specific weight threshold is reached, as measured by a balance to detect lithium saturation, the propeller lifts the lithium-saturated, fullerene wafers from the solution, and (4b) new wafers are attached to the propeller; however, anyone skilled in process engineering would likewise consider a modular propeller design for immediate unit replacement to introduce new wafers on a fresh propeller. The process is repeated until a delta weight change is no longer achieved, indicating that lithium ions have been depleted from the brine. The depleted water is pumped out, and fresh brine is pumped into the chamber to restart the cycle. (5, Optional) Post-Processing and Regeneration: Harvested lithium-saturated wafers may be used as energy storage components. Alternatively, lithium ions can be released from the fullerenes by altering the pH or changing the solvent environment, clearing the fullerenes for reuse in subsequent extraction cycles.

In the present invention, post-processing regeneration can be achieved following lithium extraction by submerging wafers in a compatible solvent to harvest purified lithium once the solvents disperse. This likewise dissolves and recovers the fullerene wafers for reuse, ensuring that the functional ligands remain intact during recycling. After detachment, the released fullerenes can also be washed, re-functionalized (if necessary), and redeployed onto new wafers for future extraction cycles. This recycling approach can enhance sustainable usage, reduce material costs, and enhance efficiency of the lithium extraction process over multiple cycles. Depending on the type of bonding used to attach the fullerenes, various detachment methods may provide flexibility for continuous reuse while ensuring the structural and functional integrity of the nanoparticles. As described above, a modular propeller design would further enhance harvesting efficiency with shorter cycle times for wafer replacement and processing during lithium extraction.

To further enhance the purity of the extraction process, beyond lithium scavenging, a separate filtration technology, such as those taught in the parent application, may also be applied at the effluent outlet for additional remediation applications (e.g., lead) to remove any residual impurities or capture alternative metals.

In the primary embodiment, the lithium-bound, functionalized C₆₀ fullerene wafers derived from the extraction process described herein can also be directly integrated into lithium-ion battery electrodes. This novel application leverages the unique structural properties of fullerenes to provide significant enhancements to battery performance. The hollow interior and conductive carbon shell facilitate efficient electron and ion transfer, improving the electrochemical kinetics and reducing resistance within the electrode. This structural adaptability allows lithium ions to be evenly distributed throughout the fullerene matrix, enhancing ion mobility and reducing localized concentration gradients, which can facilitate rapid charge and discharge cycles, shorter recharge times and increased power density. The spatial arrangement of lithium ions within the fullerene matrix further minimizes diffusion limitations, resulting in high energy density and capacity retention over multiple cycles.

The lithium-bound, functionalized fullerene wafers produced by the present invention can be incorporated into battery electrodes through established fabrication methods. Their inherent solubility in selected organic solvents further facilitates seamless integration into existing manufacturing pipelines, reducing the need for production process modifications. By leveraging the electrochemical, structural, and thermal properties of lithium-bound, functionalized fullerenes, those skilled in the art would recognize their applications for advancing lithium-ion battery technology, performance, safety, and operational efficiency.

The flexible nature of the functionalized fullerenes in the present invention also allows for their incorporation into various electrode configurations, including solid-state and flexible battery designs, from flexible rope-like structures for wearable technology to high-density, compact configurations for electric vehicles and grid storage applications. The unique shape and “empty cage” internal space of functionalized fullerenes could enhance efficient energy storage, potentially operating at a quantum or atomic scale where electron spin, thermal responsiveness, and interactions with gaseous or unknown impurities can create novel energy dynamics.

What is claimed:

1. A filtration and extraction system for the selective capture of lithium ions from brine and other solutions, comprising:
a. A mixing chamber with an inlet for introducing brine or other solutions;
b. A rotating propeller situated within the chamber;
c. Porous wafer substrates assembled onto the propeller, wherein the porous wafers are coated with functionalized C₆₀ fullerenes modified with crown ethers tailored to selectively bind lithium ions;
d. A mechanism for monitoring the weight of the porous wafers to determine lithium ion saturation, wherein saturated wafers are lifted and replaced to enable continuous lithium extraction; and
e. An outlet for the removal of depleted brine or other suspension, wherein the functionalized fullerenes exhibit high selectivity for lithium ions over competing cations in the brine or other suspension.

2. The filtration and extraction system of claim 1, wherein the fullerene is comprised of a C₆₀ or comparably functionalized fullerene of formula C₂_{ₙ}, wherein n is an integer selected from the group consisting of 10, 12, 13, 14, 15, . . . , and 360.

3. The filtration and extraction system of claim 1, wherein the crown ethers are 2-Aminomethyl-15-crown-5 ether covalently bonded to the fullerene surface.

4. The filtration and extraction system of claim 1, wherein the functionalization of fullerenes utilizes a Bingel or comparable reaction to introduce reactive sites for crown ether attachment.

5. The filtration and extraction system of claim 1, wherein the porous wafer substrates exhibit nano-roughened surfaces for enhanced adhesion and stability of the fullerenes.

6. The filtration and extraction system of claim 1, wherein the system operates at a rotational speed optimized to generate shear forces that thin the boundary layer around the functionalized wafers, optimizing lithium ion capture.

7. The filtration and extraction system of claim 1, wherein the functionalized fullerenes are designed to remain attached to the porous wafers under high-shear conditions.

8. The filtration and extraction system of claim 1, wherein the porous wafers are constructed from a hydrophilic material to enhance interaction with brine or other suspensions.

9. The filtration and extraction system of claim 1, further comprising a post-filtration stage for removing residual impurities from the depleted brine.

10. The filtration and extraction system of claim 1, wherein the functionalized fullerenes include a plurality of crown ethers for increased lithium ion selectivity.

11. The filtration and extraction system of claim 1, wherein the system is capable of regenerating the fullerenes for reuse by altering the pH or solvent treatment.

12. The filtration and extraction system of claim 1, wherein the functionalized fullerenes are soluble in organic solvents, facilitating their separation and regeneration.

13. The filtration and extraction system of claim 1, wherein the porous wafers are configured to maximize the surface area for lithium ion binding.

14. The filtration and extraction system of claim 1, wherein the crown ether cavities are sized to bind lithium ions while excluding ions with larger radii.

15. The filtration and extraction system of claim 1, wherein the system includes a thermal treatment step for detaching the functionalized fullerenes from the porous wafers for regeneration.

16. The filtration and extraction system of claim 1, further comprising a control unit for adjusting the rotational speed of the propeller to optimize lithium ion extraction.

17. The filtration and extraction system of claim 1, wherein the weight monitoring mechanism uses a balance to determine when the porous wafers are saturated with lithium ions.

18. The filtration and extraction system of claim 1, wherein the lithium-bound functionalized C₆₀ fullerenes are configured for direct incorporation into energy storage components, including lithium-ion battery electrodes, with lithium ion mobility, energy density, charge and discharge, and thermal and structural stability advantages over current lithium energy storage materials.
